(19) United States
(12) Patent Application Publication
(10) Pub. No.: US 2014/0106081 A1
(43) Pub. Date: Apr. 17, 2014

(54) MANUFACTURING METHOD OF FORMING UNDERTONE LAYER SURROUNDING OPTICAL FIBER WITH SINGLE-LAYER COATING

(71) Applicant: SUCCESS PRIME CORPORATION, Miao-Li County (TW)

(72) Inventors: Nien-Tsu CHIANG, Miao-Li County (TW); Kuei-Huang Chou, Miao-Li County (TW); Chih-Yu Wu, Miao-Li County (TW)

(73) Assignee: SUCCESS PRIME CORPORATION, Miao-Li County (TW)

(21) Appl. No.: 13/786,885

(22) Filed: Mar. 6, 2013

(30) Foreign Application Priority Data
Oct. 17, 2012 (TW) 101138274

(51) Int. Cl. G02B 6/02

(52) U.S. Cl. CPC G02B 6/02
USPC 427/510

(57) ABSTRACT

A manufacturing method of forming undertone layer of optical fiber with single-layer coating is provided. The optical fiber with single-layer coating includes, from the center outwards, glass core, cladding layer (outer diameter 80 um-125 um) and permanent coating (thickness 4 um-8 um). The method of forming undertone layer over permanent coating includes: placing optical fiber in a coloring machine so that coloring machine guiding optical fiber moving forwards, coloring machine having at least a mask device and a UV curing device; coating an undertone layer on permanent coating of optical fiber when optical fiber passing mask device, the thickness of undertone layer being 3-200 um; irradiating UV onto optical fiber passing UV curing device to solidify the undertone layer on permanent layer; and coloring machine collecting processed optical fiber, the coating strip force of undertone layer of optical fiber being less than 1 Newton.

### FIELD OF THE INVENTION

The present invention generally relates to a technique of optical fiber with single-layer coating, and more specifically to a manufacturing method of forming an undertone layer on an optical fiber with single-layer coating.

### BACKGROUND OF THE INVENTION

The inventor filed a patent application of optical fiber with single-layer coating to U.S. Patent and Trademark Office (U.S. Pat. No. 8,374,474). The structure of the optical fiber with single-layer coating includes a glass core, a cladding layer and a permanent coating, wherein the glass core is the channel for optical signal transmission, and the cladding layer is formed by crystal glass core with lower refractivity. The optical signal transmission is conducted through the difference in respective refractivity of the glass core and the cladding layer. The main feature of the optical fiber is that a single layer of permanent coating is coated over the cladding layer, and no additional material is coated over the permanent coating so that the optical fiber with single-layer coating has the advantages of high flexibility and convenience of butting deployment. For example, when butting two optical fibers, a knife is used to shear through the permanent coating on the outmost layer and the blade contacts the cladding layer to cause a slight knife mark. When force is applied on the optical fiber near the knife mark, the cladding layer is broken to form a leveled end surface. Finally, a connecter is used to connect the two optical fibers. The above design facilitates fast optical fiber butting with convenience and ease. An additional advantage of the optical fiber with single-layer coating is that the optical fiber with single-layer coating uses permanent coating layer made of tough plastic material to protect the crystal optical fiber so that the optical fiber with single-layer coating can ensure repetitive plugging and unplugging of the optical fiber into the connector, up to thousands of times, which outperforms with known optical fibers.

A commercial optical fiber usually includes 8, 12 or even 24 cores of optical fibers. Difficulty or confusion may occur during butting each respective core of the plurality of optical fiber if no color is provided for identification. The aforementioned optical fiber with single-layer coating, while easy for butting, the resulted effect of directly applying a layer of color dye on the permanent coating is poor. Thus, the plurality of cores of has similar appearance, which is difficult to distinguish. Hence, it is desirable to devise a solution to add color for convenience distinguishing when butting.

### SUMMARY OF THE INVENTION

The primary object of the present invention is to provide a manufacturing method of forming undertone layer on the optical fiber with single-layer coating. The surface of the undertone layer can show a predefined color; and when the color is not sufficiently obvious, another layer of dye can be coated over the undertone layer so that the optical fiber with single-layer coating has a distinguishable color. As such, when applied to optical fiber cable with a plurality of optical fibers with single-layer coating, the optical fiber butting is easy and convenient to pair up the optical fibers to be connected by the color so as to reduce the butting time. The undertone layer still possesses the advantage of easy processing of the optical fiber with single-layer coating as well as provides convenience of distinguishing optical fibers by color.

To achieve the above object, the method of the present invention is applied to the optical fiber with single-layer coating. The optical fiber with single-layer coating includes, from the center outwards, a glass core, a cladding layer and a permanent coating. The outer diameter of the cladding layer is 80 um-125 um. The thickness of the permanent coating is 4 um-8 um. The manufacturing method of undertone layer of the present invention includes: placing the optical fiber with single-layer coating in a coloring machine so that the coloring machine guiding the optical fiber moving forwards, the coloring machine having at least a mask device and a UV (ultraviolet) curing device; coating an undertone layer on the permanent coating of the optical fiber when the optical fiber passing the mask device, the thickness of the undertone layer being 3-200 um; irradiating UV onto the optical fiber passing the UV curing device to solidify the undertone layer on the permanent layer; and the coloring machine collecting processed optical fiber, the coating strip force of the undertone layer of the optical fiber being less than 1 Newton.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of the structure of the optical fiber manufactured by the method according to the invention; and

FIG. 2 shows a flowchart of the present invention.

### DETAILED DESCRIPTION OF THE PREFERRED EMBODIMENTS

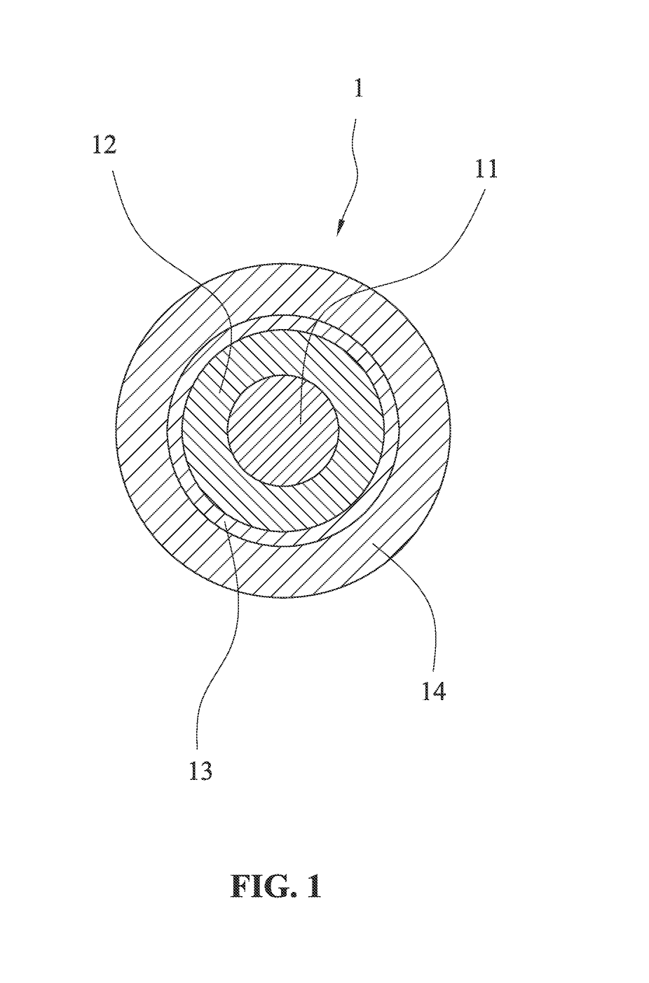

FIG. 1 shows a schematic view of the structure of the optical fiber manufactured by the method according to the invention. The manufacturing method of undertone layer of the present invention is applicable to an optical fiber 1 with single-layer coating. The optical fiber 1 with single-layer coating includes, from the center outwards, a glass core 11, a cladding layer 12 and a permanent coating 13. The outer diameter of the cladding layer 12 is 80 um-125 um. The thickness of the permanent coating 13 is 4 um-8 um. An undertone layer 14 is formed over the permanent coating 13.

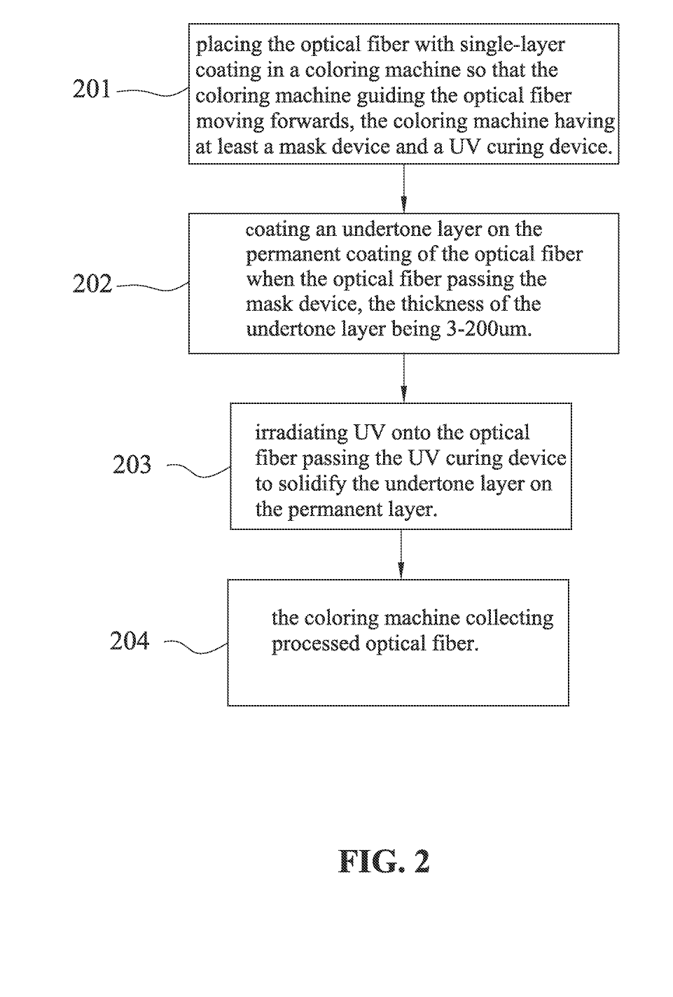

As shown in FIG. 2, the manufacturing method of undertone layer of the present invention includes the following steps:

Step 201: placing the optical fiber with single-layer coating in a coloring machine so that the coloring machine guiding the optical fiber moving forwards, the coloring machine having at least a mask device and a UV curing device.

Step 202: coating an undertone layer on the permanent coating of the optical fiber when the optical fiber passing the mask device, the thickness of the undertone layer being 3-200 um.

Step 203: irradiating UV onto the optical fiber passing the UV curing device to solidify the undertone layer on the permanent layer.

Step 204: the coloring machine collecting processed optical fiber, the coating strip force of the undertone layer of the optical fiber being less than 1 Newton.

The present invention is to coat the undertone layer 14 over the permanent layer 13. To achieve good adhesion between the two layers, the undertone layer 14 of the present invention is made of acrylic material. The undertone layer 14 is to provide color for visual distinguishing to the optical fiber 1 with single-layer coating. The present embodiment uses two approaches to achieve the object of color distinguishing.

1. The first approach is to add color dye to the material used for the undertone layer 14. To avoid affecting the properties of the optical fiber, the color dye is less than 10% of the undertone layer in volume base. In step 202, an undertone layer added with color dye is adhered to the permanent coating. When the undertone layer is solidified on the permanent coating, the color of the color dye added to the undertone layer is shown.

2. The second approach is to process again, such as, by coating or spraying, to adhere another layer of color dye. As the undertone layer can thoroughly integrate with the color dye layer, the peeling-off problem is avoided and the color dye layer is used for identifying optical fibers to pair up for butting.

The optical fiber 1 with single-layer coating can apply the method of the present invention to form an undertone layer on the outside without interfering with the original property of easy and convenient butting. The present embodiment further restricts the coating strip force of the undertone layer 14 to be less than 1 Newton, described as follows.

The present invention uses two approaches. The first approach is to directly adjust the recipe of the acrylic material for the undertone layer; and the second approach is to change the structure of the undertone layer. For example, the undertone layer can further includes an acrylic coating layer of low degree of polymerization and an acrylic coating layer of high degree of polymerization. The acrylic coating layer of low degree of polymerization is at the inner layer and the acrylic coating layer of high degree of polymerization at the outer layer. To reduce the coating strip force, the thickness of the acrylic coating layer of low degree of polymerization is thicker than the thickness of the acrylic coating layer of high degree of polymerization. In other words, the thickness ratio between the acrylic coating layer of low degree of polymerization and the acrylic coating layer of high degree of polymerization is greater than 1, and preferably 2.

The thickness of the undertone layer of the present embodiment is 3-200 um, and preferably 40-100 um.

In summary, the method of the present invention can form an undertone layer over the optical fiber with single-layer coating, and the undertone layer can show a color or allow other color material to adhere to enhance the visual distinguishing to facilitate pairing up the optical fibers for butting operation.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A manufacturing method of forming undertone layer of optical fiber with single-layer coating, applicable to the optical fiber having a structure of single-layer coating, the optical fiber with single-layer coating comprising, from the center outwards, a glass core, a cladding layer and a permanent coating; the cladding layer having an outer diameter of 80-125 um and the permanent coating having a thickness of 4 um-8 um; the manufacturing method of forming undertone layer comprising:
placing the optical fiber with single-layer coating in a coloring machine so that the coloring machine guiding the optical fiber moving forwards, the coloring machine having at least a mask device and a UV (ultraviolet) curing device;
coating an undertone layer on the permanent coating of the optical fiber when the optical fiber passing the mask device, the thickness of the undertone layer being 3-200 um;
irradiating UV onto the optical fiber passing the UV curing device to solidify the undertone layer on the permanent layer; and
the coloring machine collecting processed optical fiber, the coating strip force of the undertone layer of the optical fiber being less than 1 Newton.

2. The manufacturing method as claimed in claim 1, wherein the undertone layer further comprises an inner acrylic coating layer of low degree of polymerization and an outer acrylic coating layer of high degree of polymerization; and the thickness ratio between the inner acrylic coating layer of low degree of polymerization and the outer acrylic coating layer of high degree of polymerization is greater than 1.

3. The manufacturing method as claimed in claim 2, wherein the thickness ratio between the inner acrylic coating layer of low degree of polymerization and the outer acrylic coating layer of high degree of polymerization is greater than 2.

4. The manufacturing method as claimed in claim 1, wherein the undertone layer is made of acrylic material.

5. The manufacturing method as claimed in claim 1, wherein the undertone layer has a non-transparent color, the color depends on the dye added and the added dye is less than 10% in volume of the undertone layer.

6. The manufacturing method as claimed in claim 1, wherein a color dye layer is formed over the undertone layer.

7. The manufacturing method as claimed in claim 1, wherein the undertone layer has a thickness of 40-100 um.
